(19) United States
(12) Patent Application Publication
(10) Pub. No.: US 2023/0421080 A1
(43) Pub. Date: Dec. 28, 2023

(54) METHOD AND DEVICE FOR SYNCHRONOUS MOTOR CONTROL

(71) Applicant: SAMI SHAMOON COLLEGE OF ENGINEERING (R.A.), Beer Sheva (IL)

(72) Inventors: Zvi VAINER, Beer-Sheva (IL); Boris EPSHTEIN, Beer-Sheva (IL); Dmitry BAIMEL, Beer-Sheva (IL); Maxim RADKIN, Beer-Sheva (IL)

(21) Appl. No.: 18/253,021

(22) PCT Filed: Nov. 17, 2021
(86) PCT No.: PCT/IL2021/051369

§ 371 Date: May 15, 2023

Related U.S. Application Data
(60) Provisional application No. 63/114,550, filed on Nov. 17, 2020.

(51) Int. Cl. H02P 21/18; H02P 21/12; H02P 21/34; H02P 21/36

(52) U.S. Cl. CPC H02P 21/18; H02P 21/12; H02P 21/34; H02P 21/36

(57) ABSTRACT

A method for controlling a synchronous motor that has a stator and a rotor, comprising: correcting the frequency, phase, and values of the motor's feeding voltages, as well as the value of its magnetic flux as a function of the angle between stator and rotor magnetic fields vectors of said synchronous motor, wherein said angle derivative an angular speeds mismatch between said vectors.

### FIELD OF THE INVENTION

The present invention relates to the field of synchronous motors. More particularly, the invention relates to synchronous motors with permanent magnet rotors or excitation from a current in an excitation (field) winding, when the stator windings are fed from a network with a constant frequency or fed from an autonomous variable frequency source—inverter or cycloconverter. This invention particularly relates to synchronous motor start, pull-in synchronism process, and static and dynamic stability at synchronous operation mode. In another aspect, the invention relates to reducing the dimensions, mass, cost of producing, and electrical losses per unit of power of the synchronous motor, which is, increasing its efficiency.

### BACKGROUND OF THE INVENTION

The main requirements for the operation of a synchronous motor are reliable start-up and pull-in synchronism herewith providing relatively small starting currents, as well as dynamic and static stability of the motor operation in synchronous rotation mode, including with changes in speed and load on the motor shaft.

The main known methods to provide these requirements are as follows: when the stator windings are fed from a stationary network of constant frequency, synchronous motors with an excitation winding and starting short-circuited windings on the rotor are used. Pull-in synchronism occurs in two stages. At the first stage, the motor is accelerated to a speed close to the synchronous one by using said starting winding or by employing an additional auxiliary motor, after which a direct current is supplied to the excitation winding and the motor, after one or several oscillations, is pulled into synchronism. At synchronous mode, the specified short-circuited winding reduces (damps) oscillations and helps keep the motor's dynamic stability.

The disadvantage of this method is that the motor cannot achieve synchronous rotation speed and stops in some cases. This occurs when the excitation (field) current is applied to the excitation (field) winding. In such a case, two oppositely directed impulses of torque (that is, the torque product and the time of its action) appear, which change signs every 180° of change in the angle between the rotor fields and stator. Two oppositely directed impulses of torque are repulsive and attractive components of the alternating impulse of torque are not equal, since the time of their existence is not the same and depends on the value of the slip. Thus, these components of the impulse of torque also depend on the slip (Zvi Vainer, Boris Epshtein, Saad Tapuchi, Yoram Horen, Pavel Strazhnikov, Moshe Averbukh and AlonKuperman, “Synchronous Motor Pull-in Process Analysis”, Journal of Circuits, Systems and Computers, Vol. 24, No. 6 (2015), 1550088 (13 pages)). The greater the difference between the torque's attracting and repulsive impulses, the greater probability of successful pull-in synchronism of the motor.

At synchronous operation, the short-circuited winding has limited damping capabilities. Besides, it increases the weight, dimensions, cost, and electrical losses of the motor.

When the motor's stator windings are fed from the frequency inverter, the motor's start and further operation occur in synchronous rotation mode. However, dynamic electromagnetic loads during speed control or mechanical loads on the motor shaft can also lead to a pull-out of synchronism and emergency braking.

It is an object of the present invention to provide a reliable starting and pull-in synchronous motor synchronism. The main idea of the proposed invention is the design of a method that allows increasing the synchronizing component of the impulse of the electromagnetic torque (attractive component) of the motor, and reducing its braking (or repulsive) component.

Another object of the invention is to provide static and dynamic stability of synchronous rotation of a synchronous motor when the mechanical load is changed.

An additional object of the invention is the maintenance of the static and dynamic stability of the synchronous rotation of a synchronous motor while controlling its rotation speed.

An additional object of the invention is the ability to exclude from a number of designs of synchronous motors an additional short-circuited rotor winding performing the functions of preliminary start-up and maintaining dynamic stability. The winding can be replaced by a feedback system for the motor's load angle (or power angle) δ, providing the same functions with a simultaneous increase of the efficiency of the motor's operation.

An additional object of the invention is the development of a method for recuperative braking of a synchronous motor. The transition of a synchronous machine from the motor mode to the energy generation mode, which occurs when the motor is in braking mode, is a natural mode for a synchronous machine, when the order of the stator and rotor field vectors is changed and is accompanied by automatic (natural) energy recuperation without any additional actions. The proposed method makes it possible to determine the change in the direction of energy movement by measuring the angle between the fields of the rotor and stator and, in accordance with it, to adjust the required direction of energy.

It is still an object of the present invention to provide a device that measures the angle between the total vectors of the fields formed in the stator and the rotor, called the load angle (or power angle) in the mode of synchronous rotation of the motor is the other object of the invention.

Other objects and advantages of the invention will become apparent as the description proceeds.

### SUMMARY OF THE INVENTION

A method for controlling a synchronous motor that has a stator and a rotor, comprising: correcting the frequency, phase, and values of the motor's feeding voltages, as well as the value of its magnetic flux as a function of the angle between stator and rotor magnetic fields vectors of said synchronous motor, wherein said angle derivative an angular speeds mismatch between said vectors.

According to an embodiment of the invention, the controlling of the synchronous motor includes starting mode of synchronous rotation and recuperative braking of said synchronous motor.

According to an embodiment of the invention, a pull-in of the synchronous motor into a mode of synchronous rotation of the rotor and its magnetic field with the field (herein synchronous mode of operation), formed by the currents in the stator windings, as well as maintaining static and dynamic stability of the motor in the synchronous mode of operation, is provided by the phase, frequency, and amplitude correcting of said fields, thus measuring the angle between said fields and its derivative are parameters that ensures the accuracy of correcting.

According to an embodiment of the invention, the starting of the synchronous motor with an excitation (field) winding on the rotor and feeding of the stator windings from a voltage network of a constant frequency, comprising correcting an angular speed of the rotor and its field to the angular velocity of the stator field by supplying a direct excitation (field) current only at such measured values of the angle between the rotor and the stator field, in which an impulse of the electromagnetic torque causes the acceleration of the rotor rotation in the direction of its synchronization with the stator field, and is not applied when its action causes the braking effect.

According to an embodiment of the invention, the starting of the synchronous motor with an excitation (field) winding on the rotor and feeding of the stator windings from a constant frequency voltage network, correcting the angular speed of the rotor to the angular velocity of the stator field by supplying the excitation (field) winding with a different polarity excitation (field) current, while its polarity is changed with slip frequency depending on the angle between the position of the rotor and the stator field vector in such a way, that the impulse of electromagnetic (developed) torque constantly acts in the direction of acceleration of the rotor rotation up to its pull-in synchronization with the stator field.

According to an embodiment of the invention, the starting of the synchronous motor with an excitation (field) winding on the rotor and feeding of the stator windings from a constant frequency voltage network, comprising regulating the excitation (field) current value as a function of the rotor speed, while the rotor speed changes during the starting process.

According to an embodiment of the invention, the start of a synchronous motor with an excitation (field) winding or permanent magnets on the rotor, stator winding of which is fed by power supply voltage, modulated by value as a function of the angle between the magnetic field vectors of stator and rotor, the value of said angle is changed with the slip frequency. The feeding voltage is applied to the stator winding at the values of said angle corresponding to the moment in the direction of synchronization of the rotor speed with the stator field velocity and is not applied at the values of the angle corresponding to the moment in the direction of rotor braking.

According to an embodiment of the invention, in order to increase the static and dynamic stability of the operation of synchronous rotation of the synchronous motor with an excitation (field) winding on the rotor and feeding of the stator windings from a constant frequency voltage network, the value of the excitation (field) current is regulated (controlled) as a function of the angle between the fields of the rotor and stator and its derivative.

According to an embodiment of the invention, in order to increase the static and dynamic stability of the operation of the synchronous motor with permanent magnets on the rotor and feeding of the stator windings from a variable frequency inverter or cycloconverter, the voltage value of the frequency inverter or cycloconverter is corrected as a function of the angle between the fields of the rotor and stator, and the frequency and phase of the inverter or cycloconverter are corrected as a function of the derivative of said angle.

According to an embodiment of the invention, in order to increase the static and dynamic stability of the operation of the synchronous motor with an excitation (field) winding on the rotor and feeding of the stator windings from a frequency inverter or a cycloconverter, the value of the excitation (field) current is corrected as a function of the angle between the fields of the rotor and stator and its derivative, and the frequency and voltage phases of the frequency inverter or a cycloconverter are corrected as a function of the derivative of said angle.

According to an embodiment of the invention, the recuperative braking of the synchronous motor comprising switching the direction of the energy flow through the power supply source to said motor and vice versa in accordance with a measured value of the angle between the fields of the rotor and stator.

In another aspect, the present invention relates to an angle measuring device for measuring the angle between a transverse axis of a rotor and a stator magnetic field vector of a synchronous motor, comprising: a rotor position sensor, a fundamental harmonic filter of the stator feeding voltages, a phase discriminator and a differentiator, while the rotor position sensor is installed on a shaft of the motor, the fundamental harmonic filter of the stator feeding voltages connected to one of the phases of the stator winding voltages source, the outputs of the rotor position sensor and the filter are connected to two inputs of the phase discriminator, and one of the outputs of the phase discriminator is connected to the input of the differentiator, and the outputs of the phase discriminator and the differentiator are output signals applied to the inputs of motor control systems of the angle measuring device.

According to an embodiment of the invention, the stator windings of the motor are connected to a constant frequency voltage source, and wherein the rotor windings, on the shaft of which a tachogenerator is installed, and said measuring device are connected to a controller, wherein the outputs of the measuring device and the output of the tachogenerator are connected to the controller inputs, the output of which is connected to the input of said controlled rectifier, thereby enabling controlling of the synchronous motor.

According to an embodiment of the invention, the stator windings are connected to a voltage source of variable frequency, in which the rotor magnetic field is formed by permanent magnets, for measuring the angle between the transverse axis of the rotor and the vector of the stator magnetic field, and a frequency detector, characterized in that both outputs of said measuring device and the output of the frequency detector, are connected to the input of said variable frequency source, thereby enabling controlling of the synchronous motor.

According to an embodiment of the invention, the stator windings are connected to a source of variable frequency, and the rotor windings are connected to a controlled rectifier, characterized in that an output of said angle measuring device is connected to one of the inputs of the controlled rectifier, to a second input of which an output of the rotor speed sensor is connected, a third input of which is connected to an output of the speed measuring device, and one of the outputs of the differentiator is connected to the third input of the controlled rectifier, and the second output of the differentiator is connected to one of the inputs of the variable frequency power supply of the stator windings, to the second input of which the frequency detector output is connected.

### BRIEF DESCRIPTION OF THE DRAWINGS

In the drawings:

FIG. 1 shows a block diagram of a control system of a synchronous motor with an excitation winding on the rotor and stator windings, fed from a constant frequency network, according to an embodiment of the invention;

FIG. 2 shows a block diagram of a control system of a synchronous motor with permanent magnets on the rotor and stator windings, fed from an inverter, according to an embodiment of the invention;

FIG. 3 shows a block diagram of a control system of a synchronous motor with an excitation winding on the rotor and stator windings, fed from an inverter, according to an embodiment of the invention;

FIGS. 4A-4C demonstrate the process of generating a signal at the output of an internal angle sensor during start-up and asynchronous mode of motor rotation, according to an embodiment of the invention; and

FIG. 5 demonstrates the process of generating a signal at the output of the internal angle sensor during synchronous motor rotation according to an embodiment of the invention.

### DETAILED DESCRIPTION OF THE INVENTION

Throughout this description, the term “synchronous motor” refers to an Alternative Current (AC) motor in which, at a steady-state, the rotation of the shaft is synchronized with the frequency of the supply current; the rotation period is exactly equal to an integral number of AC cycles. Synchronous motors contain multiphase AC electromagnets on the motor's stator that create a magnetic field that rotates in time with the oscillations of the line current. The rotor with permanent magnets or electromagnets turns in step with the stator field at the same rate and, as a result, provides the second synchronized rotating magnet field of any AC motor.

A synchronous motor control device, an angle measuring device, and a method of controlling a synchronous motor according to exemplary embodiments of the present invention will now be described in detail with reference to the accompanying drawings. These embodiments may be combined, other embodiments may be utilized, and structural changes may be made without departing from the spirit or scope of the present invention. Therefore, the following detailed description is not to be taken in a limiting sense, and the appended claims and their equivalents define the scope of the present invention. Therefore, it should be noted that from the following discussion, alternative embodiments of the structures and methods disclosed herein will be readily recognized as viable alternatives that may be employed without departing from the principles of the claimed invention.

According to an embodiment of the invention, the method takes advantage of a parameter that defines the current state between angular speed and vectors of stator and rotor field angle. This parameter affects the motor's supplying voltages and, accordingly, the motor's mode of operation. It makes it possible to adjust synchronous rotation between vectors of stator and rotor fields. This parameter is the angle δ between the stator field vector and the spatial position of the magnetized rotor's transverse axis, that is, the motor load angle.

According to an embodiment of the invention, in a synchronous motor in all modes of its operation, the angle δ between the fields formed in the stator and rotor and its derivative are measured. The measured specified parameters of angle δ are used as phase feedback signals. They affect the frequencies, phases, and values of one or both of the indicated fields, adjusting them to ensure their synchronous rotation within the permissible phase mismatch between them and maintain equilibrium between the electromagnetic (developed) torque, developed by the motor, and the torque of the mechanical load on its shaft.

This method, the unified basis of which for all design varieties of synchronous motors with different sources of formation of stator and rotor fields, is the idea of phase, frequency, and amplitude auto-tuning of the vectors of the rotating fields of the rotor and stator, providing their phase mismatch within the angle between them from 0° to 90°, at which stable motor's operation is ensured.

An additional advantage provided by the invention is the ability to form any electric drive's mechanical characteristics with a synchronous motor. According to an embodiment of the invention, the system is capable of obtaining any required mechanical characteristic of an electric drive of any shape: hard, soft, or combined. The ability to form any required mechanical characteristics is because there is feedback from the angle between the stator's vectors and the system's rotor magnetic fields. This angle is a function of the load on the motor shaft. By varying the depth of feedback, including certain specified sections, it is possible to form any required mechanical characteristic.

Synchronous Motor Feeding from the Network of Constant Frequency and Excitation (Field) Winding

Known in the art start system of a synchronous motor includes two stages. At the first stage of the start-up process, the rotor with the excitation winding is short-circuited to a resistor, and with the help of an additional short-circuited winding placed on the rotor is accelerated in asynchronous mode up to the sub-synchronous rotation speed. In the second stage, a direct current is applied to the field winding. An alternating torque appears with the slip frequency. The positive component, that is, the component of this torque acting in the direction of synchronization, under favorable conditions, completes the adjustment of the rotor speed to synchronous speed. Under unfavorable conditions, the motor enters either the braking mode or the mode of uncontrolled oscillations.

In the mode of synchronous rotation of the motor, the indicated short-circuited winding has a damping anti-oscillatory effect, which contributes to the motor's dynamic stability. The damping effect is limited by the construction and the possibility of placing the specified winding.

The proposed method and device solve the problems of starting and maintaining the dynamic and static stability of the motor's synchronous rotation by constructing a closed-loop control system for supplying the excitation current 6 angle function and its derivative.

While the motor starts, the control system supplies a constant excitation (field) current only at those values of the angle δ. The electromagnetic (developed) torque accelerates the rotation of the rotor in the direction of its synchronization. Since with such regulation, the torque is unidirectional and acts in the direction of motor synchronization, then the supply of the excitation current, in contrast to the known method, can be started at large slip values in the limit at zero motor rotation speed.

Another way of starting, which increases the pull-in synchronization process's intensity and smoothness, is to apply a bipolar voltage to the excitation winding at the start-up stage. Moreover, if at angles δ from 0° to 90°, the supplied excitation (field) current's polarity is positive. At angles from 90° to 180° degrees, the polarity of the excitation (field) current is negative. Thus, a continuous electromagnetic (developed) torque pulling into synchronism is aroused.

After the motor had been pulled into the synchronous mode of operation, the feedback signal's proportional component by the angle δ affects the amplitude of the maximum electromagnetic torque developed by the motor. With an increase of the mechanical load, the maximum torque increases and, thereby, the static stability margin of the motor operation increases.

The differential component of the said feedback signal acts similarly to a motor's damping winding, reducing the resulting oscillations. However, in contrast to the damper winding, the depth of said feedback can be adjusted within wide limits, making it possible to achieve greater dynamic stability than that which the damper winding can provide. A complete rejection of the additional damper winding is possible to allow the same motor power to reduce its dimensions, weight, and electrical losses.

Permanent Magnet Synchronous Motor with Stator Windings Fed by a Frequency Inverter

The most common control system for a synchronous motor with such sources of stator and rotor fields formation is the slave control system of the commutation of switching devices of frequency inverters as the function of the rotor's angular position. In general, it is called “Permanent Magnet Brushless DC Motors”. In such a system, there are no problems with the synchronization of the stator and rotor fields.

Such a system's disadvantages are relatively high construction complexity, low efficiency due to relatively high electrical losses, high starting currents, and non-linear control characteristics. When the stator windings are powered from an autonomous inverter, the synchronous motor must be in synchronous rotation mode both at start-up and in operating mode. The dynamic forces, associated with rapid changes in the load on the motor shaft or the inverter's frequency, can lead to an emergency braking or pull-out of synchronism of the motor.

The solution to the problem within the framework of the proposed method is the feedback by the derivative of the measured angle δ affecting the inverter's frequency. This feedback also dampens oscillations and increases dynamic stability, as in feeding from the power supply of a constant frequency source (mains).

Synchronous Motor Feeding from Cycloconverter or Frequency Inverter with Excitation (Field) Winding on the Rotor

Both at start-up mode and in the operating mode, the rotor of a synchronous motor must rotate synchronously with the stator field. As in the case of a permanent magnet synchronous motor, a synchronous motor with a field winding on the rotor must maintain a synchronous mode of operation regardless of dynamic forces arising for various reasons or changes in the frequency of the electric power supply device. In the case of a motor with an excitation (field) winding on the rotor, static stability is provided by feedback by the angle δ, which affects the magnitude of the excitation (field) current, and dynamic stability is provided by feedback by the derivative of the angle δ, affecting on the excitation (field) current and frequency of the inverter (cycloconverter), or on one of the specified parameters.

### A Device for Measuring the Angle Between the Stator and Rotor Fields

According to an embodiment of the invention, the device comprises a rotor position sensor, a fundamental harmonic filter of the stator winding supply voltage, a phase discriminator, and a differentiating device.

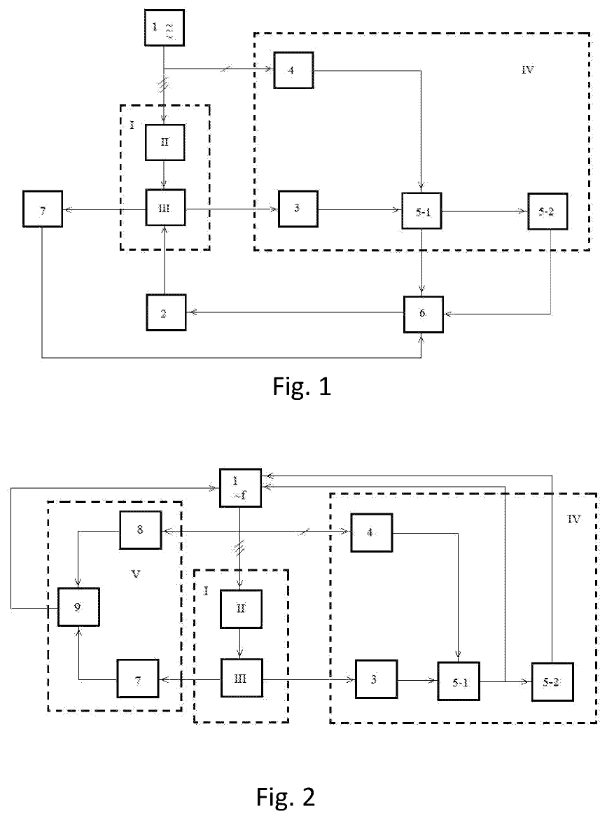

Referring now to the drawings. When the stator of a synchronous motor with an excitation (field) winding on the rotor is fed from a standard mains voltage with a constant frequency and voltage, stable start and synchronous rotation are implemented according to the diagram shown in FIG. 1. In this diagram, the stator II of a synchronous motor I is fed from a standard mains supply voltage 1 with constant voltage and frequency, and the rotor III is fed from a regulated power supply 2. A rotor position sensor 3 and a speed measuring device (tachogenerator) 7 are installed on the rotor's shaft. The output signal of the rotor position sensor 3 determines the rotor's current angular position and, accordingly, the vector of its magnetic field formed by the excitation (field) current from the power source 2. After filtering and isolating its fundamental harmonic by a filter 4, the voltage of one of the phases of the supply mains 1 is applied to one of the inputs of the discriminator of the internal angle δ of the motor load 5, to the second input of which the output signal of the rotor position sensor 3 is supplied. At the output of the discriminator 5, two signals are generated, one of which 5-1 is proportional to the value of the angle δ, and the second one 5-2 is proportional to the derivative of this angle. The initial adjustment of the discriminator is performed under the synchronous rotation of the no-loaded motor. In this case, the rotor position sensor 3 is set to a position where the voltage at the discriminator's output will be equal to zero.

While starting the motor I with a power source 1 connected to the rotor III, there are two main options: soft motor's start and pull-in synchronism.

In the first option, the regulator 6 allows supplying a constant excitation current only at those values of the angle δ, at which the electromagnetic (developed) torque accelerates the rotor in the direction of synchronization its rotation with the stator field, and turns the direct excitation current off at the angle δ, at which the electromagnetic (developed) torque brakes its rotation.

In the second option, the excitation (field) current is also supplied at those δ angles, at which in the first option it is turned off due to the brake effect, but the polarity of the excitation current changes. It leads to the fact that during the entire start-up process, a unidirectional electromagnetic (developed) torque is created, which accelerates the rotor in the direction of synchronization with the stator field.

When the motor rotates, the feedback by load angle δ regulates the maximum electromagnetic (developed) torque, increasing it with increased mechanical load, thereby increasing the motor's static stability. The differential component of the feedback dampens the oscillations arising from various disturbances of the mechanical or electromagnetic (developed) torque of the rotating motor and, thereby, increases its dynamic stability.

When the stator of a synchronous motor with permanent magnets on the rotor is fed from an independent source of a variable frequency inverter or cycloconverter, both the start-up process and rotation in the operating mode occur with synchronous rotation of the fields of the rotor and stator. In this case, ensuring the motor's stable operation is realized according to the block diagram shown in FIG. 2. In this case, feedback by the derivative of the load angle δ is used, affecting the frequency of the power supply 1. This feedback leads to damping of the resulting oscillations and, accordingly, to an increase in the motor's dynamic stability.

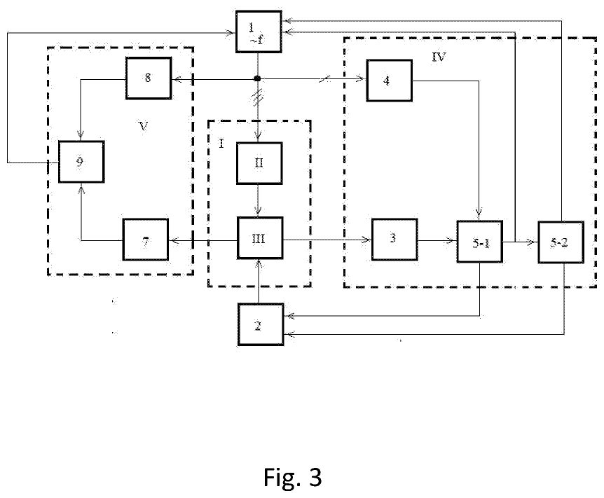

When the motor is operating with an excitation (field) winding on the rotor and an autonomous variable frequency inverter or cycloconverter supplying the stator winding, the proposed control system's connection is shown in FIG. 3. In this case, the feedback by load angle δ is connected only to the excitation (field) current regulator 2, and the angle derivative feedback is connected both to the input of the autonomous variable frequency inverter or cycloconverter supplying the stator windings and to the excitation (field) current regulator, or one of them. The speed measuring device (tachogenerator) 7 is connected to the third input of the excitation (field) current regulator 2, and the second output of said speed measuring device (tachogenerator) 7 is connected to one of the inputs of speed difference discriminator 9. The second input of speed difference discriminator 9 is connected to the output of the frequency-to-voltage converter 8. The output of the speed difference discriminator 9 is connected with one of the inputs of the autonomous variable frequency inverter or cycloconverter 1.

It should be understood that the division of the method is illustrated by the diagrams in FIGS. 1-3 into separate operations, each represented by a different block, has been selected for convenience and clarity only. Alternative division of the illustrated method into operations is possible with equivalent results. Such an alternative division of the method into operations should be considered as included within the scope of embodiments of the present invention.

It should also be understood that, unless indicated otherwise, the illustrated order of operations as represented by blocks of the diagrams has been selected for the sake of convenience and clarity only. The order of execution of illustrated operations may be modified, or the illustrated method's operations may be executed concurrently, with equivalent results. Such reordering of operations illustrated by blocks of the flowchart should be considered as included within the scope of embodiments of the present invention.

All the above will be better understood through the following illustrative and non-limitative graphs examples.

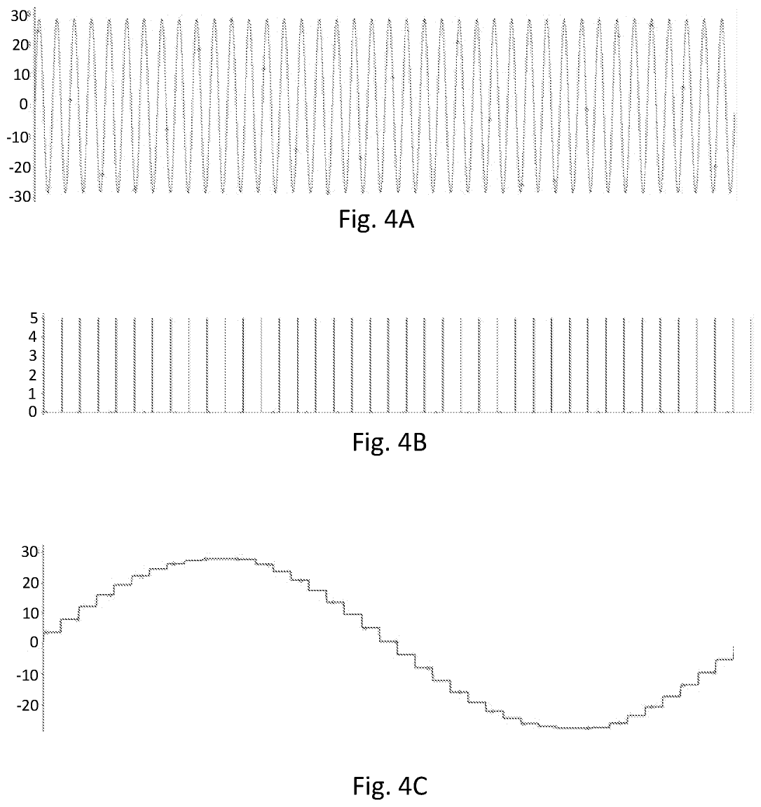

FIGS. 4A-4C demonstrate the process of generating a signal at the output of the internal angle sensor during start-up and asynchronous motor rotation. FIG. 4A shows the network source signal (i.e., the main network signal), which is connected to the phase detector. FIG. 4B demonstrates the signal generated by the position rotor sensor (i.e., rotor position sensor output signal) and is connected to another input of the phase detector. FIG. 4C shows the phase detector output signal.

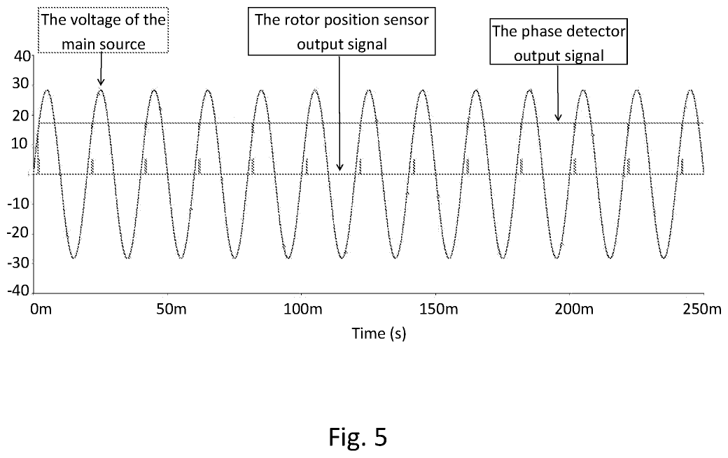

FIG. 5 demonstrates the process of generating a signal at the output of the internal angle sensor during synchronous motor rotation.

As will be appreciated by the skilled person, the proposed method and the arrangement described in the figures ensure a reliable start and pull-in synchronism of a synchronous motor with a field winding on the rotor, the stator fed from a network of constant frequency and voltage. Moreover, the method enables keeping the motor's static and dynamic stability with a field winding on the rotor, the stator fed from a network of constant frequency and voltage, under dynamic load, or the magnitude of the supply voltage change. The method also enables reliable starting and stable steady-state operation of a synchronous motor, fed by an adjustable frequency inverter, including the process of dynamic load changes when the motor speed is regulated and controlled. In this case, it is possible to exclude short-circuited damping starting windings from the motor design. It allows reducing the mass of the motor, its dimensions, the cost of production, as well as reducing the energy losses of the motor associated with currents in the specified windings during start-up and synchronous operation.

All the above descriptions and examples have been given for the purpose of illustration and are not intended to limit the invention in any way. Many different mechanisms, methods of measuring, electronic and logical elements can be employed, all without exceeding the scope of the invention.

1. A method for controlling a synchronous motor that has a stator and a rotor, comprising: correcting the frequency, phase, and values of the motor's feeding voltages, as well as the value of its magnetic flux as a function of the angle between stator and rotor magnetic fields vectors of said synchronous motor, wherein said angle derivative an angular speeds mismatch between said vectors.

2. The method according to claim 1, wherein the controlling of the synchronous motor includes starting mode of synchronous rotation and recuperative braking of said synchronous motor.

3. The method according to claim 2, wherein a pull-in of the synchronous motor into a mode of synchronous rotation of the rotor and its magnetic field with the field in a synchronous mode of operation, formed by the currents in the stator windings, as well as maintaining static and dynamic stability of the motor in the synchronous mode of operation, is provided by the phase, frequency, and amplitude correcting of said fields, thus measuring the angle between said fields and its derivative are parameters that ensures the accuracy of correcting.

4. The method according to claim 2, wherein the starting of the synchronous motor with an excitation field winding on the rotor and feeding of the stator windings from a voltage network of a constant frequency, comprising correcting an angular speed of the rotor and its field to the angular velocity of the stator field by supplying a direct excitation field current only at such measured values of the angle between the rotor and the stator field, in which an impulse of the electromagnetic torque causes the acceleration of the rotor rotation in the direction of its synchronization with the stator field, and is not applied when its action causes the braking effect.

5. The method according to claim 3, wherein the starting of the synchronous motor with an excitation field winding on the rotor and feeding of the stator windings from a constant frequency voltage network, correcting the angular speed of the rotor to the angular velocity of the stator field by supplying the excitation field winding with a different polarity excitation field current, while its polarity is changed with slip frequency depending on the angle between the position of the rotor and the stator field vector in such a way, that the impulse of electromagnetic developed torque constantly acts in the direction of acceleration of the rotor rotation up to its pull-in synchronization with the stator field.

6. The method according to claim 3, wherein the starting of the synchronous motor with an excitation field winding on the rotor and feeding of the stator windings from a constant frequency voltage network, comprising regulating the excitation field current value as a function of the rotor speed, while the rotor speed changes during the starting process.

7. The method according to claim 2, wherein the start of a synchronous motor with an excitation field winding or permanent magnets on the rotor, stator winding of which is fed by power supply voltage, modulated by value as a function of the angle between the magnetic field vectors of stator and rotor, value of said angle is changed with the slip frequency, wherein the feeding voltage is applied to stator winding at the values of said angle corresponding to the moment in the direction of synchronization of the rotor speed with the stator field velocity, and is not applied at the values of the angle corresponding to the moment in the direction of rotor braking.

8. The method according to claim 2, wherein in order to increase the static and dynamic stability of the operation of synchronous rotation of the synchronous motor with an excitation field winding on the rotor and feeding of the stator windings from a constant frequency voltage network, the value of the excitation field current is regulated controlled as a function of the angle between the fields of the rotor and stator and its derivative.

9. The method according to claim 2, wherein in order to increase the static and dynamic stability of the operation of the synchronous motor with permanent magnets on the rotor and feeding of the stator windings from a variable frequency inverter or cycloconverter, the voltage value of the frequency inverter or cycloconverter is corrected as a function of the angle between the fields of the rotor and stator, and the frequency and phase of the inverter or cycloconverter are corrected as a function of the derivative of said angle.

10. The method according to claim 2, wherein in order to increase the static and dynamic stability of the operation of the synchronous motor with an excitation field winding on the rotor and feeding of the stator windings from a frequency inverter or a cycloconverter, the value of the excitation field current is corrected as a function of the angle between the fields of the rotor and stator and its derivative, and the frequency and voltage phases of the frequency inverter or a cycloconverter are corrected as a function of the derivative of said angle.

11. The method according to claim 2, wherein the recuperative braking of the synchronous motor comprises switching the direction of the energy flow through the power supply source to said motor and vice versa in accordance with a measured value of the angle between the fields of the rotor and stator.

12. An angle measuring device for measuring the angle between a transverse axis of a rotor and a stator magnetic field vector of a synchronous motor, comprising: a rotor position sensor, a fundamental harmonic filter of the stator feeding voltages, a phase discriminator and a differentiator, while the rotor position sensor is installed on a shaft of the motor, the fundamental harmonic filter of the stator feeding voltages connected to one of the phases of the stator winding voltages source, the outputs of the rotor position sensor and the filter are connected to two inputs of the phase discriminator, and one of the outputs of the phase discriminator is connected to the input of the differentiator, and the outputs of the phase discriminator and the differentiator are output signals applied to the inputs of motor control systems of the angle measuring device.

13. The device according to claim 12, wherein the stator windings of the motor are connected to a constant frequency voltage source, and wherein the rotor windings, on the shaft of which a tachogenerator is installed, and said measuring device is connected to a controller, wherein the outputs of the measuring device and the output of the tachogenerator are connected to the controller inputs, the output of which is connected to the input of said controlled rectifier, thereby enabling controlling of the synchronous motor.

14. The device according to claim 12, wherein the stator windings are connected to a voltage source of variable frequency, in which the rotor magnetic field is formed by permanent magnets, for measuring the angle between the transverse axis of the rotor and the vector of the stator magnetic field, and a frequency detector, characterized in that both outputs of said measuring device and the output of the frequency detector, are connected to the input of said variable frequency source, thereby enabling controlling of the synchronous motor.

15. The device according to claim 12, wherein the stator windings are connected to a source of variable frequency, and the rotor windings are connected to a controlled rectifier, characterized in that an output of said angle measuring device is connected to one of the inputs of the controlled rectifier, to a second input of which an output of the rotor speed sensor is connected, a third input of which is connected to an output of the speed measuring device, and one of the outputs of the differentiator is connected to the third input of the controlled rectifier, and the second output of the differentiator is connected to one of the inputs of the variable frequency power supply of the stator windings, to the second input of which the frequency detector output is connected.
